(19) United States
(12) Patent Application Publication
(10) Pub. No.: US 2026/0066514 A1
(43) Pub. Date: Mar. 5, 2026

(54) TRANSMISSION LINE STRUCTURE AND FABRICATING METHOD OF THE SAME

(71) Applicants: HongQiSheng Precision Electronics (QinHuangdao) Co., Ltd., Hebei Province (CN); Avary Holding (Shenzhen) Co., Ltd., Shenzhen (CN); Garuda Technology Co., Ltd., New Taipei City (TW)

(72) Inventor: Cheng-Jia LI, Shenzhen (CN)

(21) Appl. No.: 18/817,934

(22) Filed: Aug. 28, 2024

(51) Int. Cl. H01P 3/02; H01P 11/00

(52) U.S. Cl. CPC H01P 3/02; H01P 11/001

(57) ABSTRACT

A transmission line structure and a fabricating method of the same are provided. The transmission line structure includes a baseboard, two transmission lines, a grounding plate, a metal plate, a shielding element, and an elastic conductor. The baseboard has an air hole. The transmission lines are spaced side by side, and are disposed on the baseboard. The grounding plate is separated from the transmission lines, and is disposed on the baseboard. The metal plate is separated from the baseboard. The transmission lines are located between the baseboard and the metal plate. The shielding element is disposed on the metal plate and extends toward the baseboard. The elastic conductor is disposed between the baseboard and the metal plate, and is electrically connected to the grounding plate and the metal plate. The baseboard, the metal plate, and the elastic conductor define a transmission cavity that communicates with the air hole.

### BACKGROUND

### Technical Field

The present application relates to a transmission line structure and a fabricating method of the same.

### Description of Related Art

Signal transmission manners of a transmission line include single-ended signaling and differential signaling, where the single-ended signaling uses one transmission line to transmit signals. A single-ended impedance of the transmission line is a characteristic impedance of the transmission line with respect to a reference plane (such as the ground). The differential signaling uses two transmission lines to transmit a differential signal, where the differential signal is a signal pair with the same amplitudes and opposite phases. In consideration of the transmission line coupling effect, the differential impedance of the two transmission lines is less than twice the single-ended impedance. Therefore, in consideration of impedance matching, the general transmission line structure can only be applied to a single signaling manner (i.e., single-ended signaling or differential signaling), and cannot be applied to two signaling manners.

### SUMMARY

At least one embodiment of the present application provides a transmission line structure and a fabricating method of the same, where the transmission line structure is applied to both single-ended signaling and differential signaling.

At least one embodiment of the present application provides a transmission line structure, which includes a baseboard, two transmission lines, a grounding plate, a metal plate, a first shielding element, and an elastic conductor. The baseboard has an air hole. The two transmission lines are spaced side by side and are disposed on the baseboard. The grounding plate is separated from the two transmission lines, and is disposed on the baseboard. The metal plate is separated from the baseboard. The two transmission lines are located between the baseboard and the metal plate. The first shielding element is disposed on the metal plate and extends toward the baseboard. The elastic conductor is disposed between the baseboard and the metal plate, and is electrically connected to the grounding plate and the metal plate. The baseboard, the metal plate, and the elastic conductor define a transmission cavity that communicates with the air hole. The air hole is configured to change a pressure in the transmission cavity. When the pressure in the transmission cavity is less than or equal to a pressure threshold, the first shielding element moves towards the baseboard so that the first shielding element is in contact with the baseboard and separates the two transmission lines. When the pressure in the transmission cavity is greater than the pressure threshold, the elastic conductor extends and the first shielding element moves away from the baseboard, so that a gap is formed between the first shielding element and the baseboard.

At least one embodiment of the present application provides a fabricating method of the transmission line structure, which includes: providing a baseboard and a metal layer, where the metal layer is disposed on the baseboard; patterning the metal layer so as to form two transmission lines and a grounding plate, where the two transmission lines are spaced side by side and the grounding plate is separated from the two transmission lines; forming an air hole on the baseboard, where the air hole does not overlap with the two transmission lines and the grounding plate; providing a metal plate; forming multiple shielding elements on the metal plate; and bonding the baseboard and the metal plate via an elastic conductor. The elastic conductor is connected between the grounding plate and the metal plate, and is electrically connected to the grounding plate and the metal plate. The baseboard, the metal plate, and the elastic conductor define a transmission cavity that communicates with the air hole. The shielding elements each extend towards the baseboard and are located in the transmission cavity.

Based on the above description, in the transmission line structure disclosed in the above embodiments, the transmission line structure has a transmission cavity, and the pressure in the transmission cavity can be changed through the air hole, so that the elastic conductor changes in height, and the shielding elements can move towards or away from the baseboard, so as to separate the two transmission lines or not to affect a coupling effect between the two transmission lines. Therefore, the transmission line structure is applied to both single-ended signaling and differential signaling.

### BRIEF DESCRIPTION OF THE DRAWINGS

For a more complete understanding of the embodiments and their advantages, description is given below with reference to the attached accompanying drawings:

FIG. 1 is a schematic partial top view of a transmission line structure according to at least one embodiment of the present application;

FIG. 2 is a schematic sectional diagram along a section line I-I′ in FIG. 1;

FIG. 3 is a schematic sectional diagram where a pressure in a transmission line structure of FIG. 2 is greater than a pressure threshold;

FIG. 4 is a schematic sectional diagram of a step of providing a baseboard and a metal layer in a fabricating method of the transmission line structure in FIG. 2;

FIG. 5 is a schematic sectional diagram of a step of forming a metal structure in the fabricating method of the transmission line structure in FIG. 2;

FIG. 6 is a schematic sectional diagram of a step of forming two transmission lines, multiple grounding plates, and an air hole in the fabricating method of the transmission line structure in FIG. 2;

FIG. 7 is a schematic sectional diagram of a step of providing a metal plate and a shielding plate in the fabricating method of the transmission line structure in FIG. 2;

FIGS. 8A, 8B and 8C are schematic sectional diagrams of a step of forming multiple shielding elements and metal structures in the fabricating method of the transmission line structure in FIG. 2;

FIG. 9 is a schematic sectional diagram of a step of covering the surface with a shielding insulation layer in the fabricating method of the transmission line structure in FIG. 2; and

FIG. 10 is a schematic sectional diagram of a step of bonding the baseboard and the metal plate in the fabricating method of the transmission line structure in FIG. 2.

### DETAILED DESCRIPTION

For clearly introducing the technical features of the present application below, the dimensions (such as length, width, thickness, and depth) of components (such as layers, membranes, baseboards, and areas) in the figures will be scaled up disproportionately, and the number of some components will be reduced. Accordingly, the description and interpretation of the embodiments below shall not be limited to the number of components and the dimensions and shapes of the components shown in the figures, but shall encompass dimensions, shapes and deviations therebetween as a result of actual manufacturing processes and/or tolerances. For example, a flat surface shown in a figure may have a feature of roughness and/or nonlinearity, while an acute angle shown in a figure may be circular. Therefore, the components shown in the present application are mainly used for schematic purposes, and are not intended to accurately depict the actual shapes of the components, nor are they used to limit the claims of the patent application.

Secondly, the words “about”, “approximately” or “substantially” appearing herein encompass not only clearly recorded values and ranges of values, but also allowable deviation ranges understood by persons of ordinary skill in the art, in which the deviation ranges may be determined by errors resulting from measurements, and the errors are due, for example, to limitations of both a measuring system and process conditions. In addition, the word “about” can mean within one or more standard deviations of the above values, such as ±30%, ±20%, ±10% or ±5%. The terms “about”, “approximately” or “substantially” and the like used in the present application may be used to select acceptable deviation ranges or standard deviations based on optical, etchable, mechanical or other properties, rather than a single standard deviation to apply all of the above optical, etchable, mechanical or other properties. In addition, for the purpose of clearly illustrating the following embodiments, functionally identical or similar components are indicated by the same numbers.

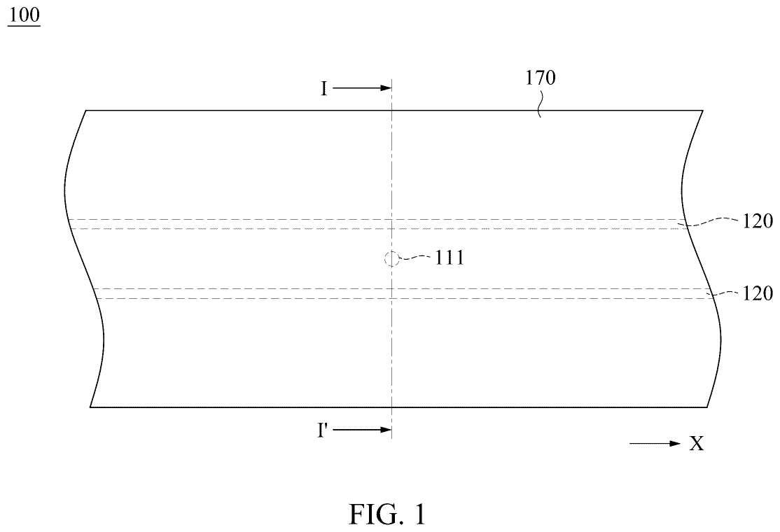

FIG. 1 is a schematic partial top view of a transmission line structure 100 according to at least one embodiment of the present application, where the transmission line structure 100 can be used for transmission of electrical signals, and can be adjusted for single-ended signaling or differential signaling without breaking the structure. For example, the transmission line structure 100 may be adjusted into a single-ended signaling structure or a differential signaling structure by changing its internal pressure.

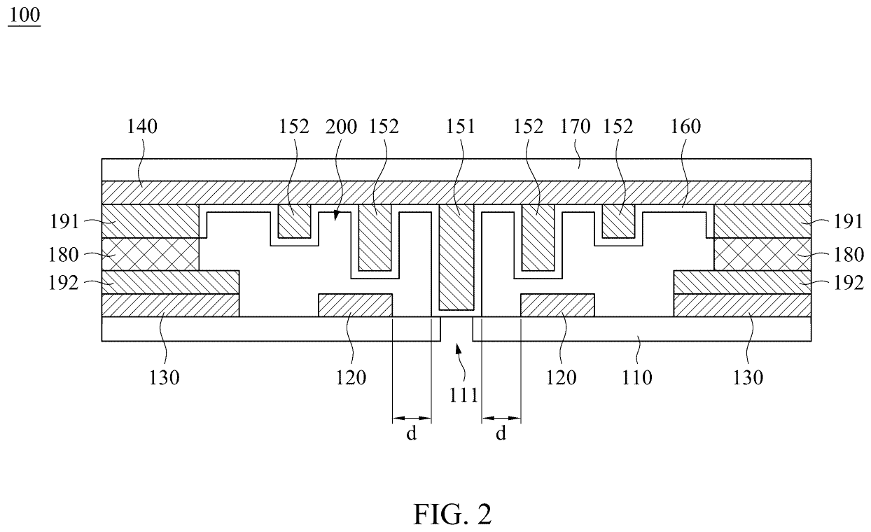

FIG. 2 is a schematic sectional diagram along a section line I-I′ in FIG. 1, where a pressure in the transmission line structure 100 is less than or equal to a pressure threshold in FIG. 2 and the transmission line structure 100 is applicable to single-ended signaling. The pressure threshold may be a standard atmospheric pressure, namely, 1 atm (unit of the atmospheric pressure). Referring to FIGS. 1 and 2, the transmission line structure 100 includes a baseboard 110, multiple transmission lines 120, multiple grounding plates 130, a metal plate 140, multiple shielding elements 151 and 152, a shielding insulation layer 160, a shielding plate 170, and multiple elastic conductors 180.

The baseboard 110 extends in a transmission direction (a direction X) and has at least one air hole 111. The baseboard 110 may be made of a wave-absorbing material, such as carbon-based wave-absorbing material, ferrite wave-absorbing material, conductive polymer wave-absorbing material, metal fiber wave-absorbing material, or ceramic wave-absorbing material. Further, the carbon-based wave-absorbing material may include graphene, carbon nanotubes, or carbon fiber; and the ferrite wave-absorbing material may be an iron oxide or a combination of iron oxide and other metal oxides, such as nickel oxides, zinc oxides or magnesium oxides.

The conductive polymer wave-absorbing material includes a conductive material and a polymer, where the conductive material is, for example, carbon black or metal. The metal fiber wave-absorbing material includes metal and base material, in which the metal is, for example, iron, copper, or aluminum, and the base material is, for example, resin or rubber. The ceramic wave-absorbing material may include barium titanate or strontium titanate. It should be noted that, if the wave-absorbing material of the baseboard 110 is conductive, the surface of the baseboard 110 may be covered with an insulating layer to avoid short circuits caused by the multiple transmission lines 120 and the multiple grounding plates 130.

The multiple transmission lines 120 are spaced side by side and disposed on the baseboard 110. As shown in FIG. 2, the transmission line structure 100 includes two transmission lines 120. These transmission lines 120 may be located in the middle region of the baseboard 110 and also extend in direction X. The width of each transmission line 120 may range from 20 microns to 100 microns. The distance between the two transmission lines 120 is less than or equal to 500 microns, so that the two transmission lines 120 produce a coupling effect during signal transmission. The material of these transmission lines 120 may be copper, aluminum or silver. In particular, the air hole 111 may be located between the two transmission lines 120.

The multiple grounding plates 130 are separated from these transmission lines 120 and are also disposed on the baseboard 110. For example, these grounding plates 130 are located at two sides of these transmission lines 120 and also extend along direction X, where these grounding plates 130 do not contact any of the transmission lines 120. The material of these grounding plates 130 may be the same or similar to the material of these transmission lines 120, such as copper, aluminum or silver. The metal plate 140 is spaced from the baseboard 110, and these transmission lines 120 and these grounding plates 130 are located between the metal plate 140 and the baseboard 110. The metal plate 140 also extends in direction X, and may be a high-hardness plate, such as a steel plate, an aluminum alloy plate or an iron plate.

The multiple shielding elements 151 and 152 may be wall-shaped, and are disposed at intervals on the metal plate 140, and extend towards the baseboard 110. These shielding elements 151 and 152 also extend in direction X, and further vary in height. The shielding element 151 is located between multiple shielding elements 152 and between the two transmission lines 120, and overlaps with the air hole 111. The shielding element 151 is the longest, while other shielding elements 152 gradually decrease in height in a direction away from the shielding element 151. In particular, the shielding elements 151 and 152 have a width greater than or equal to 10 microns. The diameter of the air hole 111 may be the same as or slightly less than the width of the shielding elements 151 and 152. The material of the shielding elements 151 and 152 may be metal, such as copper. For example, the shielding elements 151 and 152 may be formed by stacking copper layers.

The shielding insulation layer 160 covers the shielding elements 151 and 152 and the metal plate 140, and faces the baseboard 110. The shielding insulation layer 160 can shield the electromagnetic wave generated during signal transmission by the transmission lines 120. In addition, the shielding insulation layer 160 can isolate the electrical signal to avoid a short circuit caused by contact between the multiple shielding elements 151 and 152 and the transmission lines 120. The material of the shielding insulation layer 160 may be a ferrite wave-absorbing material. Further, the shielding insulation layer 160 ranges from 5 microns to 15 microns in thickness.

The shielding plate 170 is disposed on the metal plate 140 and also extends in direction X. The metal plate 140 is located between the shielding plate 170 and the shielding elements 151 and 152. The shielding plate 170 can also shield the electromagnetic wave generated during signal transmission by the transmission lines 120. The material of the shielding plate 170 may be a wave-absorbing material that is the same or similar to that of the baseboard 110, such as the carbon-based wave-absorbing material, the ferrite wave-absorbing material, the conductive polymer wave-absorbing material, the metal fiber wave-absorbing material, or the ceramic wave-absorbing material.

The elastic conductors 180 are disposed between the baseboard 110 and the metal plate 140. For example, these elastic conductors 180 are located at two sides of these transmission lines 120 and also extend in direction X. In particular, the baseboard 110, the metal plate 140, and the elastic conductors 180 define a transmission cavity 200, and the transmission cavity 200 communicates with the air hole 111. These elastic conductors 180 are electrically conductive, so that these elastic conductors 180 can be electrically connected to the grounding plates 130 and the metal plate 140. These elastic conductors 180 also have elasticity of extension such that the height (i.e., thickness) of these elastic conductors 180 varies with the pressure in the transmission cavity 200.

These elastic conductors 180 may be made of resin or silver powder. The ratio of the elongation to the original height of these elastic conductors 180 may range from 80% to 500%, where the original height of these elastic conductors 180 may range from 30 microns to 100 microns.

In the example of FIG. 2, the transmission line structure 100 further includes multiple metal structures 191 and 192. The metal structures 191 are respectively disposed between the multiple elastic conductors 180 and the metal plate 140, so that these elastic conductors 180 are electrically connected to the metal plate 140 via these metal structures 191. These metal structures 192 are respectively disposed between the multiple elastic conductors 180 and the multiple grounding plates 130 such that these elastic conductors 180 are electrically connected to these grounding plates 130 via these metal structures 192. The shielding insulation layer 160 covers the side walls of these metal structures 191. In addition, there is good adhesion between these elastic conductors 180 and these metal structures 191 and 192. Further, the grounding plates 130, the metal plate 140, the shielding elements 151 and 152, the elastic conductors 180, and the metal structures 191 and 192 form a reference ground with respect to these transmission lines 120. The material of these metal structures 191 and 192 may be copper.

In other embodiments, the transmission line structure 100 may not have these metal structures 191 and 192. That is, these elastic conductors 180 are directly electrically connected to the metal plate 140 and these grounding plates 130. Thus, the grounding plates 130, the metal plate 140, the shielding elements 151 and 152, and the elastic conductors 180 form a reference ground with respect to these transmission lines 120.

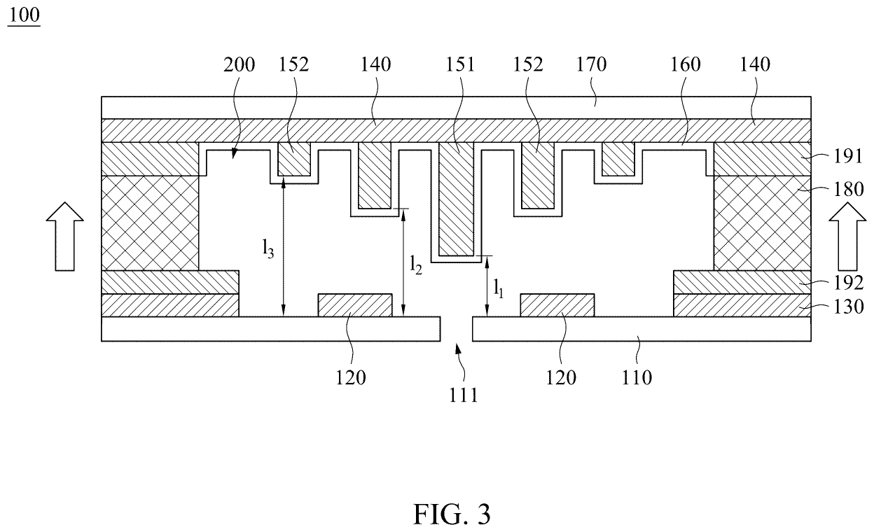

FIG. 3 is a schematic sectional diagram where the pressure in the transmission line structure 100 of FIG. 2 is greater than the pressure threshold, where the transmission line structure 100 is applicable to differential signaling. Referring to FIG. 3, the pressure in the transmission cavity 200 may be changed by injecting air from the air hole 111 with a pump. When the pressure in the transmission cavity 200 is greater than the pressure threshold, the pressure in the transmission cavity 200 drives the elastic conductors 180 to extend, and these shielding elements 151 and 152 move in a direction away from the baseboard 110 to create a gap between the shielding element 151 and the baseboard 110. Therefore, the shielding element 151 does not separate the two transmission lines 120. These shielding elements 152 also do not contact the baseboard 110 and these transmission lines 120. It should be noted that because the metal plate 140 is a plate with high hardness, the metal plate 140 can support these shielding elements 151 and 152 to avoid deformation of the transmission cavity 200.

The two transmission lines 120 may affect each other without the isolation of the shielding element 151 and the shielding insulation layer 160, so that the two transmission lines 120 produce a coupling effect when transmitting signals. The baseboard 110, the metal plate 140, the shielding elements 151 and 152, the shielding insulation layer 160, the elastic conductors 180, and the metal structures 191 and 192 surround these transmission lines 120 to completely cover these transmission lines 120, thus shielding external electromagnetic interference.

In addition, without separating the two transmission lines 120, the shielding element 151 does not affect the coupling effect between the two transmission lines 120. Therefore, the two transmission lines 120 can be used for differential signaling. In particular, the gaps between the shielding elements 151 and 152 and the baseboard 110 may be changed by adjusting the pressure in the transmission cavity 200, thereby changing the position of the reference ground with respect to these transmission lines 120, namely, changing the distance l₁ between the shielding element 151 and the baseboard 110 and the distances l₂ and l₃ between the shielding elements 152 and the baseboard 110, so as to adjust the impedance matching between these transmission lines 120.

Referring to FIG. 2, the pressure in the transmission cavity 200 may be changed by pumping air with a pump or by natural deflating from the air hole 111. When the pressure in the transmission cavity 200 is less than or equal to the pressure threshold, these shielding elements 151 and 152 move towards the baseboard 110, and the shielding element 151 may be in contact with the baseboard 110 so that the shielding insulation layer 160 covering the shielding element 151 contacts the baseboard 110. Therefore, the shielding element 151 separates the two transmission lines 120 and can block the air hole 111. These shielding elements 152 do not come into contact with the baseboard 110 and these transmission lines 120. It should be noted that because these shielding elements 152 are covered with the shielding insulation layer 160, it is unlikely to cause a short circuit to these transmission lines 120 even if these shielding elements 151 and 152 come into contact with these transmission lines 120.

The distance d between the shielding insulation layer 160 covering the shielding element 151 and each transmission line 120 is greater than or equal to 10 microns. Isolated by the shielding element 151 and the shielding insulation layer 160, the two transmission lines 120 do not affect each other, so that the two transmission lines 120 do not produce a coupling effect when separately transmitting signals. The baseboard 110, the metal plate 140, the shielding elements 151 and 152, the shielding insulation layer 160, the elastic conductors 180, and the metal structures 191 and 192 surround these transmission lines 120 to completely cover these transmission lines 120, thus shielding external electromagnetic interference and shielding electromagnetic interference between these transmission lines 120. Therefore, each transmission line 120 can be used for single-ended signaling. It shall be noted that in other embodiments, the shielding elements 151 and 152 may not be covered with the shielding insulation layer 160, and the distance between the shielding element 151 and each transmission line 120 is greater than or equal to 10 microns when the shielding element 151 is contact with the baseboard 110.

It should be noted that these shielding elements 151 and 152 vary in height, so that the coverage area of the shielding insulation layer 160 increases, thereby improving the effect of shielding electromagnetic waves. Further, the shielding element 151 is covered with the most part of the shielding insulation layer 160, such that the two transmission lines 120 can be easily adjusted for single-ended signaling. These shielding elements 152 gradually decrease in height in a direction away from the shielding element 151, so that the height of the shielding element 152 closest to the shielding element 151 is significantly greater than the height of the shielding element 152 furthest away from the shielding element 151. In this way, the transmission cavity 200 has a relatively large wave-absorbing space to avoid electromagnetic wave reflection and to achieve a desired shielding effect.

In the transmission line structure 100, the transmission cavity 200 is formed by disposing the baseboard 110, the metal plate 140, the shielding elements 151 and 152, the shielding insulation layer 160, the elastic conductors 180, and the metal structures 191 and 192. Moreover, the structure uses several shielding manners, such as cavity shielding, shielding with wave-absorbing materials, and metal shielding, thus improving the shielding effect.

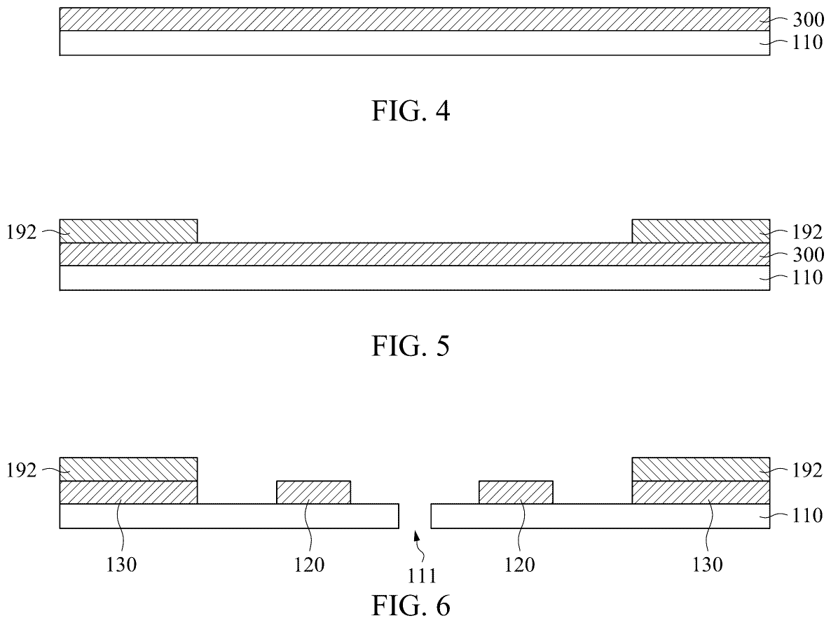

FIG. 4 is a schematic sectional diagram of a step of providing a baseboard 110 and a metal layer 300 in a fabricating method of the transmission line structure 100 in FIG. 2, and FIG. 5 is a schematic sectional diagram of a step of forming metal structures 192 in the fabricating method of the transmission line structure 100 in FIG. 2. Referring to FIG. 4, first, a baseboard 110 and a metal layer 300 are provided, where the metal layer 300 is disposed on the baseboard 110. The metal layer 300 can be a copper layer. Referring to FIG. 5, next, multiple metal structures 192 is formed on the metal layer 300, where these metal structures 192 may be formed by electroplating.

FIG. 6 is a schematic sectional diagram of a step of forming two transmission lines 120, multiple grounding plates 130, and an air hole 111 in the fabricating method of the transmission line structure 100 in FIG. 2. Referring to FIG. 6, the metal layer 300 is patterned so as to form two transmission lines 120 and multiple grounding plates 130, where these transmission lines 120 and these grounding plates 130 may be formed by etching. Afterwards, an air hole 111 is formed on the baseboard 110, and does not overlap with the two transmission lines 120 and the grounding plates 130. In FIG. 6, the air hole 111 is located between the two transmission lines 120. The air hole may be formed by either laser drilling or mechanical drilling.

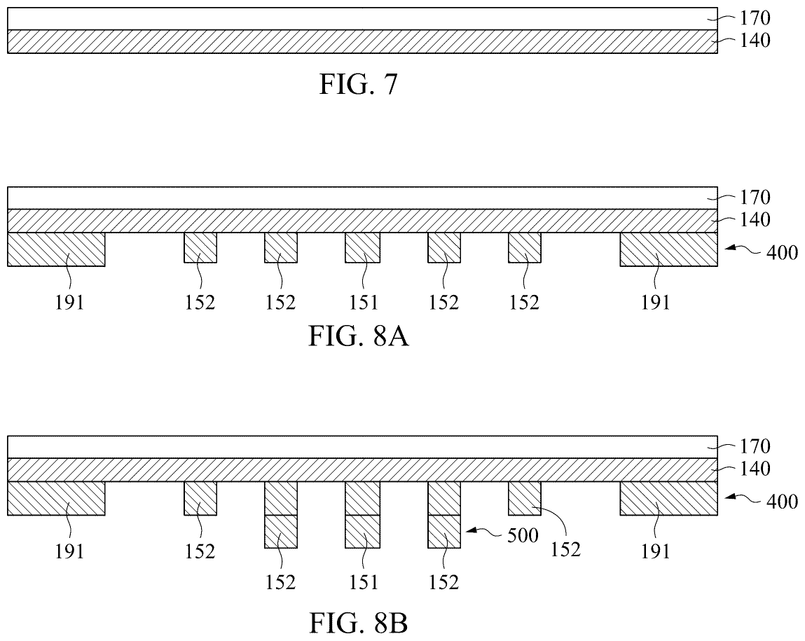

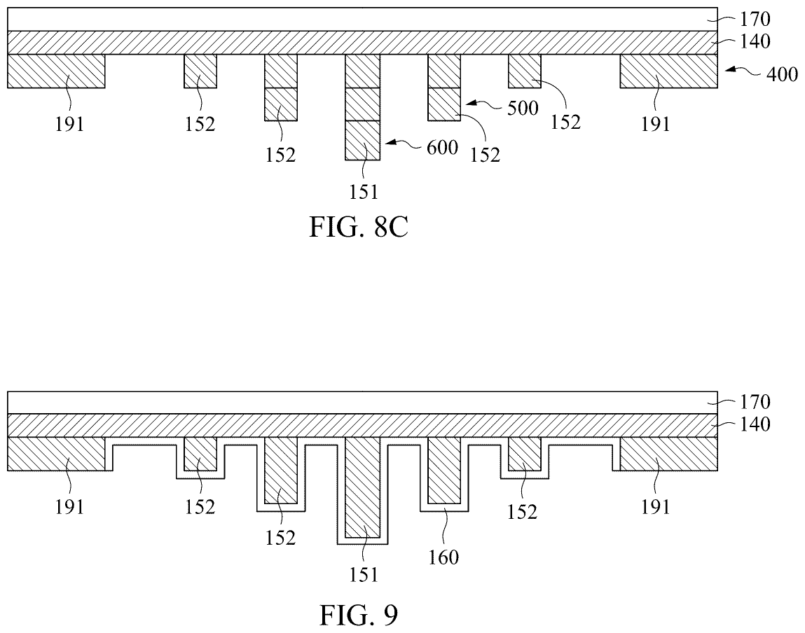

FIG. 7 is a schematic sectional diagram of a step of providing a metal plate 140 and a shielding plate 170 in the fabricating method of the transmission line structure 100 in FIG. 2; and FIGS. 8A, 8B and 8C are schematic sectional diagrams of a step of forming multiple shielding elements 151 and 152 and metal structures 191 in the fabricating method of the transmission line structure 100 in FIG. 2. Referring to FIG. 7, a metal plate 140 and a shielding plate 170 are provided, where the shielding plate 170 is disposed on the metal plate 140. Referring to FIG. 8A, a first metal layer 400 is formed by selective electroplating on the metal plate 140, where the first metal layer 400 includes the metal structures 191 and parts of the shielding elements 151 and 152. In the process of forming the first metal layer 400 by means of the selective electroplating, a mask layer may be formed on the metal plate 140 so that the metal structures 191 and parts of the shielding elements 151 and 152 are formed on a region of the mask layer where the metal plate 140 is exposed, where the mask layer may be a dry film.

Referring to FIG. 8B, then, a second metal layer 500 is formed also by the selective electroplating on the metal plate 140, where the second metal layer 500 includes parts of the shielding elements 151 and 152. Referring to FIG. 8C, next, a third metal layer 600 is formed also by the selective electroplating on the metal plate 140, where the third metal layer 600 includes part of the shielding element 151. It should be noted that the first metal layer 400, the second metal layer 500, and the third metal layer 600 are formed on the metal plate 140 at positions that are not exactly the same, so the shielding elements 151 and 152 of different heights are formed. It should be noted that the first metal layer 400, the second metal layer 500, and the third metal layer 600 may be formed using the same method.

In addition, the multiple metal structures 191 may be formed from different numbers of metal layers according to the height. In other words, in other embodiments, the metal structures 191 may be formed by the first metal layer 400 and the second metal layer 500; or by the first metal layer 400, the second metal layer 500, and the third metal layer 600. In FIGS. 8A to 8C, the first metal layer 400, the second metal layer 500, and the third metal layer 600 may be copper layers.

FIG. 9 is a schematic sectional diagram of a step of covering a surface with a shielding insulation layer 160 in the fabricating method of the transmission line structure 100 in FIG. 2. Referring to FIG. 9, the side walls of the shielding elements 151 and 152, the metal plate 140, and the metal structures 191 are coated with a shielding insulation material, so as to form a shielding insulation layer 160 on the side walls of the shielding elements 151 and 152, the metal plate 140, and the metal structures 191. It should be noted that the steps in FIGS. 4 to 6 are sequential steps, while the steps in FIGS. 7 to 9 are sequential steps. The sequence of steps in FIGS. 4 and 7 is not limited.

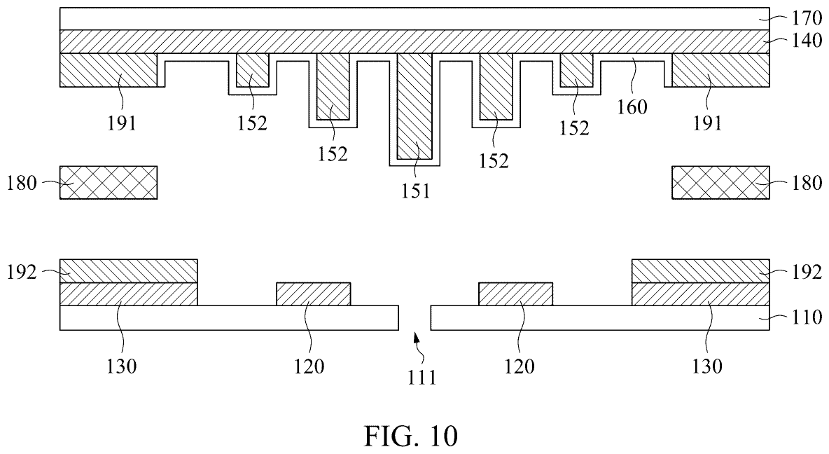

FIG. 10 is a schematic sectional diagram of a step of bonding the baseboard 110 and the metal plate 140 in the fabricating method of the transmission line structure 100 in FIG. 2. Referring to FIG. 10, the metal structures 191 face the metal structures 192, and the shielding elements 151 and 152 and the shielding insulation layer 160 face the baseboard 110 and the two transmission lines 120, where the shielding element 151 is aligned with the air hole 111. Afterwards, multiple elastic conductors 180 are disposed between the metal structures 191 and 192 such that the baseboard 110 and the metal plate 140 are bonded via these elastic conductors 180. In this way, the fabrication of the transmission line structure 100 (as shown in FIG. 2) is completed. These elastic conductors 180 are connected between these metal structures 191 and 192, and between these grounding plates 130 and the metal plate 140. The elastic conductors 180 are electrically connected to these metal structures 191 and 192, these grounding plates 130 and the metal plate 140 to form a reference ground.

To sum up, in the transmission line structure 100 disclosed by the above embodiments, the transmission line structure 100 has the transmission cavity 200, and the pressure in the transmission cavity 200 may be changed through the air hole 111, such that these elastic conductors 180 keep an original height or extend. The shielding element 151 can move towards or away from the baseboard 110, thus separating the two transmission lines 120 or not affecting the coupling effect between the two transmission lines 120. Therefore, the transmission line structure 100 can be adjusted for single-ended signaling or differential signaling without breaking the structure.

In addition, the distances l₁, l₂, and l₃ between the shielding elements 151 and 152 and the baseboard 110 can vary by adjusting the pressure in the transmission cavity 200, thereby changing the position of the reference ground with respect to these transmission lines 120. Further, the shielding element 151 is covered with the most part of the shielding insulation layer 160, such that the two transmission lines 120 can be easily adjusted for single-ended signaling. The shielding elements 152 gradually decrease in height in the direction away from the shielding element 151, so that the transmission cavity 200 has the relatively large wave-absorbing space to avoid electromagnetic wave reflection. Moreover, the transmission line structure 100 uses several shielding manners, such as the cavity shielding, the shielding with wave-absorbing materials, and the metal shielding, thus improving the shielding effect.

Although the present disclosure has been disclosed as above in embodiments, the embodiments are not intended to limit the present disclosure, and those of ordinary skill in the art may make some changes and embellishments within the spirit and scope of the present disclosure, therefore, the scope of protection of the present disclosure shall be defined in the attached claims.

What is claimed is:

1. A transmission line structure, comprising:
a baseboard having an air hole;
two transmission lines spaced side by side and disposed on the baseboard;
a grounding plate separated from the two transmission lines and disposed on the baseboard;
a metal plate separated from the baseboard, wherein the two transmission lines are located between the baseboard and the metal plate;
a first shielding element disposed on the metal plate and extending towards the baseboard; and
an elastic conductor disposed between the baseboard and the metal plate and electrically connected to the grounding plate and the metal plate, wherein the baseboard, the metal plate, and the elastic conductor define a transmission cavity that communicates with the air hole, and the air hole is configured to change a pressure in the transmission cavity,
wherein when the pressure in the transmission cavity is less than or equal to a pressure threshold, the first shielding element moves towards the baseboard so that the first shielding element is contact with the baseboard and separates the two transmission lines, and
wherein when the pressure in the transmission cavity is greater than the pressure threshold, the elastic conductor extends and the first shielding element moves away from the baseboard, so that a gap is formed between the first shielding element and the baseboard.

2. The transmission line structure of claim 1, wherein the air hole is located between the two transmission lines, and the first shielding element overlaps with the air hole.

3. The transmission line structure of claim 1, further comprising:
a plurality of second shielding elements disposed at intervals on the metal plate and extending towards the baseboard, wherein the first shielding element is located between the plurality of second shielding elements, and
wherein when the pressure in the transmission cavity is less than or equal to the pressure threshold, the plurality of second shielding elements move towards the baseboard and do not contact the baseboard and the two transmission lines.

4. The transmission line structure of claim 3, wherein the plurality of second shielding elements gradually decreases in height in a direction away from the first shielding element.

5. The transmission line structure of claim 3, further comprising:
a shielding insulation layer covering the first shielding element, the plurality of second shielding elements, and the metal plate,
wherein when the pressure in the transmission cavity is less than or equal to the pressure threshold, the shielding insulation layer covering the first shielding element contacts the baseboard.

6. The transmission line structure of claim 5, wherein the shielding insulation layer ranges from 5 microns to 15 microns in thickness.

7. The transmission line structure of claim 1, wherein a width of the first shielding element is greater than or equal to 10 microns.

8. The transmission line structure of claim 1, wherein a distance between the first shielding element and any of the two transmission lines is greater than or equal to 10 microns.

9. The transmission line structure of claim 1, wherein a distance between the two transmission lines is less than or equal to 500 microns.

10. The transmission line structure of claim 1, wherein
a shielding plate disposed on the metal plate, wherein the metal plate is located between the shielding plate and the first shielding element.

11. A fabricating method of a transmission line structure, comprising:
providing a baseboard and a metal layer, wherein the metal layer is disposed on the baseboard;
patterning the metal layer so as to form two transmission lines and a grounding plate, wherein the two transmission lines are spaced side by side and the grounding plate is separated from the two transmission lines;
forming an air hole on the baseboard, wherein the air hole does not overlap with the two transmission lines and the grounding plate;
providing a metal plate;
forming a plurality of shielding elements on the metal plate; and
bonding the baseboard and the metal plate via an elastic conductor, wherein the elastic conductor is connected between the grounding plate and the metal plate, and is electrically connected to the grounding plate and the metal plate, and the baseboard, the metal plate, and the elastic conductor define a transmission cavity that communicates with the air hole, and the plurality of shielding elements each extend towards the baseboard and are located in the transmission cavity.

12. The fabricating method of claim 11, further comprising:
after forming the plurality of shielding elements on the metal plate, covering the plurality of shielding elements and the metal plate with a shielding insulation layer.

13. The fabricating method of claim 11, wherein one of the plurality of shielding elements overlaps with the air hole.

14. The fabricating method of claim 11, wherein a width of each of the plurality of shielding elements is greater than or equal to 10 microns.

15. The fabricating method of claim 11, wherein a distance between the two transmission lines is less than or equal to 500 microns.
